(19) United States
(12) Patent Application Publication
(10) Pub. No.: US 2020/0410501 A1
(43) Pub. Date: Dec. 31, 2020

(54) VOICE RECOGNITION ALERTS(V.R.A)

(71) Applicant: ELISHA TWENEBOAH KODUA, DALLAS, TX (US)

(72) Inventor: ELISHA TWENEBOAH KODUA, DALLAS, TX (US)

(21) Appl. No.: 16/551,729

(22) Filed: Aug. 27, 2019

Related U.S. Application Data
(63) Continuation-in-part of application No. 16/455,434, filed on Jun. 27, 2019.

(51) Int. Cl. G06Q 20/40; G06Q 20/42; G06Q 20/32; G10L 17/24; G06Q 50/26

(52) U.S. Cl. CPC G06Q 20/40145; G06Q 20/425; G06Q 2230/00; G10L 17/24; G06Q 50/265; G06Q 20/3227

(57) ABSTRACT

Voice Recognition Alerts is designed to combat an unauthorized online account usage and transactions. It is an additional transaction and account management security system that will be required by the various financial institutions, online payment systems, online healthcare accounts and other online accounts that contain or require user personal information such as, full name, date of birth, social security and driver's license to confirm the validity of all transactions as well as account authentication before granting access. The verification process involves making a voice recording of an answer to a selected security question on file. The account holder will then be asked to confirm transactions by verbally providing an answer to the security question. If the answer and the voice match the one recorded on file, account access or transaction will be approved. If neither the voice nor the answer matches the one file, account or transaction will be declined.

### BACKGROUND OF THE INVENTION VOICE RECOGNITION ALERTS (VRA)

The ongoing cyber war in the world today cannot be overlooked by any organization whether it's nonprofit or for profit.

Companies and organizations holding sensitive data are particularly vulnerable to cyber-attacks;

They are the most targeted group of attackers. Even though much effort and measures have been put in place to combat these intruders, the attacks seem to be increasing every day as if nothing is being done about it. The intruders are doing everything possible to take advantage of modernday technology and rob people, organizations and corporations.

For this purpose, VOICE RECOGNITION ALERTS (VRA) is established to provide extra security to both online and offline transactions.

### DETAILED DESCRIPTION

The description of the Voice Recognition System can be detailed under the following categories;

Financial institutions

Online payment systems Healthcare accounts

Other online account users Smartphones and laptops users. Mobile sim card registration

Location details Home security Identity verifications

Gun detection

Voting

For Financial Institutions

First of all, the account holders will be required by the financial institutions to set a security question at the time of opening the account. The answer to the security questions will be in a voice from where the account holder will be prompted to speak or record the answer to the selected security question.

This voice recorded answer will be kept on file for verification purposes.

The account holder will then be asked to set a transaction limit of which verification would be required.

Any transactions beyond the set amount would require the bank to make an automated call to the account holders phone number on file and asked to confirm by answering a secret question on file.

The system will then make sure the answer to the security question matches the voice as recorded on file.

If the system recognizes the voice of the account holder then the transaction will be approved. If not, then the transaction will be declined.

Online Payment Systems

Anytime user wants to access an online payment system account, Voice Recognition Alert Verification and authentication process will be required. The account holder will be required to set a voice recording security question at the time of creating the online account. The answer to the security questions will be in a voice from where the account holder will be prompted to speak or record the answer to the selected security question.

This voice recorded answer will be kept on file for verification purposes. Anytime the user wants to access the account, a call will be made by the system to the users registered phone number on file to answer a security question on file and make sure the voice matches the recorded one on file.

User access will be denied if the recorded security answer does not match the one on file. If the user gets security answer correct but users voice does not match the recorded voice on file, there will no account access to such a user? Upon three unsuccessful attempts, the account will be temporarily blocked requiring the user to speak to a live representative at the fraud department.

Healthcare Accounts

The account holder will be required by the healthcare provider or facility to set a voice recording security question at the time of creating the online account. The answer to the security questions will be in a voice from where the account holder will be prompted to speak or record the answer to the selected security question.

This voice recorded answer will be kept on file for verification purposes. Anytime the user wants to access the account, a call will be made by the system to the users registered phone number on file to answer a security question on file and make sure the voice matches the recorded one on file.

User access will be denied if the recorded security answer does not match the one on file. If the user gets security answer correct but users voice does not match the recorded voice on file, There will no account access to such a user. Upon three unsuccessful attempts, the account will be temporarily blocked requiring the user to speak to a live representative at the fraud department. OTHER Corporations

All online accounts users who may opt-in for Voice Recognition Alert (VRA) will be required to go through VOICE RECOGNITION ALERT verification and authentication process in order to access their account.

They will be required to set up a voice recorded security question at the time account was opened or even if the account has been opened and the user opt-in for VRA, the user will be allowed to follow the process by recording their security question on file.

A call will be made by the system to the users registered phone number on file to answer a security question on file and make sure the voice matches the recorded one on file.

User access will be denied if the recorded security answer does not match the one on file. If the user gets security answer correct but users voice does not match the recorded voice on file, There will no account access to such a user? Upon three unsuccessful attempts, the account will be temporarily blocked requiring the user to speak to a live representative at the fraud department. LAPTOPS

And Smartphone Users

All laptops and smartphone users who opt-in for voice recognition alert at the initial set may will be required to voice record their answer to the selected security question on file. Users will be required to verbally provide an answer to the security question before they will be able to access their laptops and smartphones. If the system recognizes the voice of the user and the security answer matches the one on file, the phone or the laptop will be opened and the user will be able to have access. If the voice matches the one recorded on file but the security answer does not match the one on file, account access will not be granted. In the same way, if the security answer matches the on file but the voice does not match the recorded one on file, account access will be denied.

Mobile Money Account

Before you set up a mobile money account, the account holder will be required to set up a security question. The answer to the security questions will be in a voice from where the account holder will be prompted to speak or record the answer to the selected security question.

This voice recorded answer will be kept on file for verification purposes.

The account holder will then be asked to select two security keys on his/her smartphone. In case of an emergency where the account holder's life is in danger, one of the keys (danger key) will be pressed three times followed by their country's emergency line or short code before providing an answer to the voice recorded security questions on file.

This security key will then activate the location of the user and also send a signal to the customer service or the nearby law enforcement that the account holders' life is in danger.

When this happens, even if the user's voice and the security answer match the one on file, the withdrawal will not be allowed but will be placed on hold for further verification and authentication since the account holder's life is in danger. This could be that the user is being forced to withdraw money from their mobile money account.

NORMAL KEY In the case where the account holder wants to withdraw money in a safe location without his life being in danger (normal key), the other second selected key will be pressed three times to enable the user to activate and respond to the voice recorded security questions before allowing to withdraw money. If the voice and the security answer match the one on file, withdrawals will be allowed.

If the voice matches the one on file but the security answer does not, access will be denied. If neither the Voice nor the answer matches the one on file, account cases will be denied.

If the user gets the security answer correct but the voice does not match the one on file, account access will be denied. Upon three unsuccessful attempts, the account will be blocked temporarily and require the user to contact a live representative for further verifications.

For example, #hash key means danger

*key means normal not in danger.

If the user refuses to answer the call three times the system will automatically block users account temporarily for further verification.

This will help prevent fraudulent acts through mobile money accounts and also ensure the security of the users and their deposits or funds.

Mobile Sim Card Registration

Before any sim card can be registered, Voice Recognition alert process in claim 2 key selection process will be followed.

The account holder will be allowed to select a security key on his/her smartphone before registering their sim card. Existing users who have already registered their sim card will be allowed to amend their registration by selecting a security key. In case of an emergency where the account holder's life is in danger, the security keypad will be pressed three times instantly followed by their country's emergency line or short code. As soon as the user presses the key three times together with the emergency line, the system will activate the location of the user and send a signal to the nearest law enforcement that users' life is in danger.

For instance, the user in the United States select hash # as his security key. In case of danger such sickness or any life-threatening events, the user will press the hash # key three times followed by 911 and immediately the location of the user will be activated and connected to the nearest law enforcement agencies or agent which will signal to them that users' life is in danger.

User can share such keys to their immediate relatives only.

This will system will help reduce kidnapping and also ensure the safety of every country and its citizens most especially the developing countries.

Tracking Suspicious Caller Location

If VRA user wants to track the location of a suspicious caller, User will log in into VRA app immediately after the call and follow the following instructions.

Click on track last caller location. Enter your selected security key three times and hit enter key.

The location details of the caller will be displayed even if the last caller ID is unknown.

Vehicle Teft Detection with VRA

VRA also allows the user to connect the VRA Device with their vehicles where the user will be allowed to record their voice during the VRA set up. The voice will be saved on the VRA database for verification purposes

In case of vehicle lost or stolen, the VRA user will have an option to mark vehicle connected to VRA Device as lost. When this happens, the vehicle will be locked remotely device will then begin a voice verification process. In this process, VRA device will prompt the driver or anyone in the vehicle to confirm the recorded voice on file before a vehicle can be unlocked for operation. Any further delay in confirming the voice verification process or If the user voice doesn't match the recorded one on file, the vehicle information and its location details will be sent to the a nearby law enforcement agency or agent as stolen vehicle followed by vehicle alarm sound.

Using VRA to Open Doors

VRA will allow users and their family members as well as employers and their employees to record their voice on VRA door bell and alarm system. Anytime user or anyone wants to open the door, the system will prompt the user to speak to confirm the voice recorded security question on file. If the user voice matches the one on file, the door will be opened. If not, the door will remain locked until the resident or the owner comes to help.

Instant Verification and Linking of Bank Accounts with VRA

The VRA software system will allow users to be able to instantly verify their bank accounts online without going through the security deposit process.

The account holder will be allowed to record their voice on file following the VRA authorization process. Anytime user want to link bank accounts both domestics and international bank accounts, the system will prompt user to speak their security answer that was recorded during the time both accounts were opened for voice verification. If the voice and the answer match the one on file, the system will automatically link both accounts successfully. If not, both accounts cannot be linked.

This process will make it easy and more secure for user to link their various bank accounts in different countries across the world together for easily funds transfer.

Using VRA to Clock in at Work

The VRA software will allow various employees at various companies to simply record their voice at the time of hiring. This recorded voice will be kept for employees CLOCK IN verification and access to the employer's facilities and properties

Before the employee will be granted access to the company building entrance, VRA will prompt the employee to verify his/her voice by verbally providing an answer to the security question that was set at the time of hiring. If the voice and the security answer match the one on file, employee will be automatically granted access to the building.

The same process will be repeated at the time clock location. The employee will be prompted to speak their answer to the security question that was set during the hiring process. If the voice and the security answer matches the one on file, the VRA software will automatically login or clocked in the employee. If neither the voice nor the security answer matches the one on file, the employee will be denied login or clock in access.

This will help prevent the employees who are found of allowing other associates to clock in on their behalf from doing so.

It will also eradicate an unauthorized access to the company facilities and properties. Moreover, employee who uses a company electronics device such as computers, smartphones etc. to work will also go through the VRA authorization process before they can access those devices to work.

Using VRA Software to Verify Consumer Identity on Credit Report

Instead of answering series of questions on consumers public record to verify his or her identity, the VRA software will simply allow the user to verify their identity by speaking their security answer to a security question which has already been recorded and established in the system. If the security answer and the voice match the one on file, the consumer's identity will be verified.

If neither the voice nor the answer matches, the system will not be able to verify their identity.

This will help by pass answering series of questions to verify user's identity most especially when users credit report has been frozen.

Using VRA to be Withdrawing Cash, Making Cash/Check Deposit and Check Balance at the Atm

VRA software will allow its users to withdraw cash from their financial institution's ATM machine.

The VRA software will allow the user to record their answer to the security question during the time the account is being opened. This voice recorded security answers will be kept on file for verification and authentication purposes.

Anytime an account holder wants to withdraw or make cash deposit or even deposit check with their financial institution's ATM machine, there will be an option to select WITHDRAW CASH, DEPOSIT CASH/CHECK, CHECK BALANCE WITH YOUR VOICE.

When this option is selected, the system will give the user an option to enter their DATE OF BIRTH FOLLOWED BY the last four digits of their SSN or phone number that was used to open the account. After this, the system will prompt account holder to speak their answer to the selected security questions on file.

If the voice and the security answer matches the one on file, all the accounts associated with that voice will pop up on the screen asking the account holder to select the account he or she would like to withdraw money from and the amount to withdraw, account to deposit cash or check to or an account to check balance. Cash will then be dispensed, check or cash will be deposited, and balance will display on the screen.

Gun Detection with VRA Security System

The VRA security system will allow its users to be able to detect gun carriers at the entrance of any institution or retail shops or facilities. The security device at the door will be able to detect a gun on any individual that may try to enter with a gun. There will be two doors to each of the entrance of the facility. The first door to the entrance will detect the gun and the second door will automatically lock as soon as gun is detected on an individual who may try to enter the facility with a gun. The door will remain locked and the VRA device will send signal with the location details of the door to the authorities or nearby law enforcement as well as the security department of that institution that someone at the entrance has a gun. Nobody will be able to open the door until authorities rectify the situation.

Significantly, this system will help reduce an active shooting in schools, at malls, at retail shops and many other places that is opened to the general public or even private facilities.

VOTING WITH VRA SOFTWARE DURING ELECTIONS During voters registration for elections, the voter will be allowed to record their voice on file in a form of an answer to a security question. The voter will be allowed to verbally speak their answer to a chosen security questions for verification and authentication. At the time of voting, user will be allowed to enter their date of birth followed by the last four of their Social Security Number or the last four of the phone number used to register. This will verify and pull up voters' information. As soon as voter's information is verified, the VRA system will prompt user to speak their security answer to the chosen security question. If the voice matches the voice on file, all the various candidates will appear on the screen asking user to select the candidate of their choice. After the voting, the system will automatically count the number of verified voters so there will be no need for counting after voting.

Significantly, the VRA system will be able to detect and decline duplicate voice voting. The system will also detect and allow only verified voters to vote The system will again verify and decline unauthorized voting.

### DESCRIPTION OF FIGURES

From FIG. 1-FIG. 11(Original)

FIG. 1A shows Voice Recognition Alert Server used to grant or deny user access.

FIG. 1B shows Voice Recognition Alert Application Security Database used to verify financial institutions, online payment systems and healthcare account.

FIG. 2 shows how the user can use an installed VRA app by smartphone and laptop manufacturers to unlock their smart device and personal computing device.

FIG. 3 shows how the user can use an VRA software to unlock their smart device and personal computing device.

FIG. 4 shows how a user is being asked by their financial institution to verify the recorded voice on file before granting access to their online accounts.

FIG. 5 shows how the user is being asked by their online payment system providers to verify the recorded voice on file before granting access to their online accounts

FIG. 6 shows how the user is being asked by their healthcare facility to verify the recorded voice on file before granting access to their online accounts

FIG. 7 shows how the user is being asked by other online account providers to verify the recorded voice on file before granting access to their online accounts.

FIG. 8 shows how the user uses three selected keys to indicate either transaction is being done under stress or its normal transaction.

FIG. 9 shows whether user is denied or given access to a transaction that is being done under stress or not

FIG. 10 shows how the user uses the three selected security keys followed by emergency short code to send their location to the nearby law enforcement to indicate their life is in danger.

FIG. 11 shows how a user can track a suspicious caller with the VRA app

From FIG. 12-FIG. 17(Additional Figures)

FIG. 12 shows how uses the VRA software to lock their stolen vehicle and send the vehicle location to the nearby police officer

FIG. 13 shows how VRA user is allowed to use their voice to open their doors.

FIG. 14 shows how the user is being asked to instantly verify their bank accounts with their voice.

FIG. 15 shows VRA allows its users to clock in at work with their voice.

FIG. 16 shows how the user is being asked to verify their consumer identity on their credit report with their voice.

FIG. 17 shows user uses their voice to withdraw cash or make a deposit at the ATM.

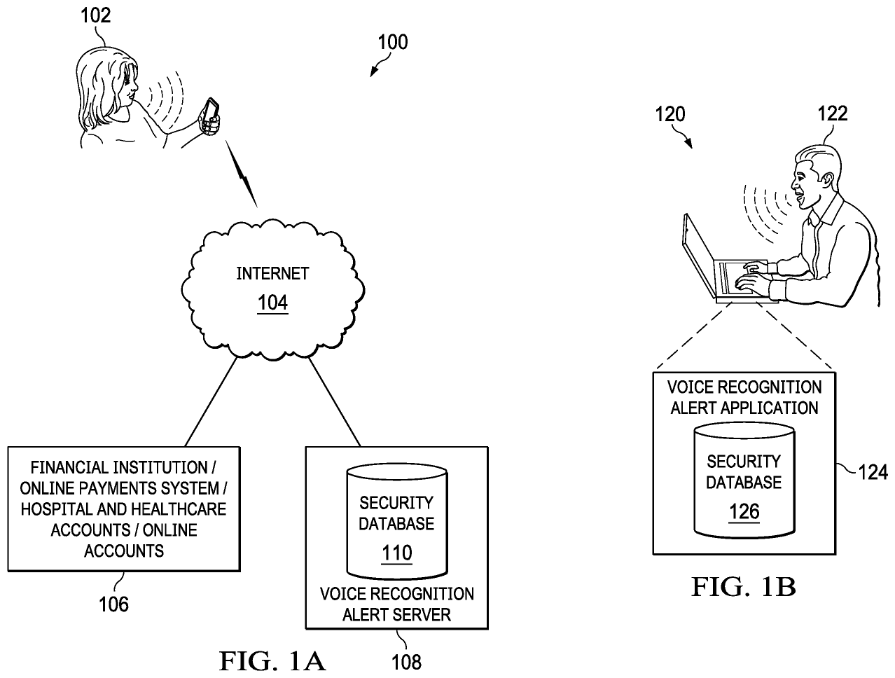

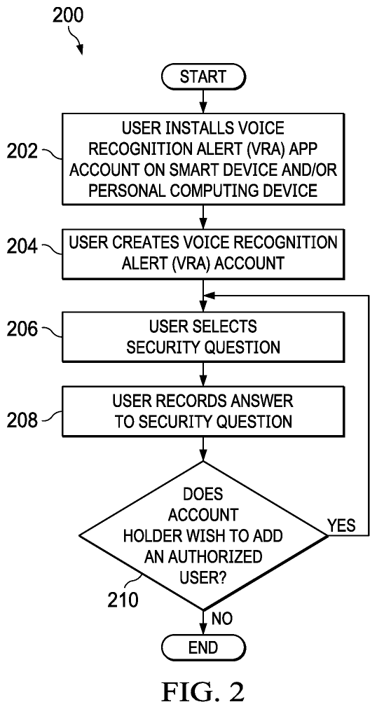

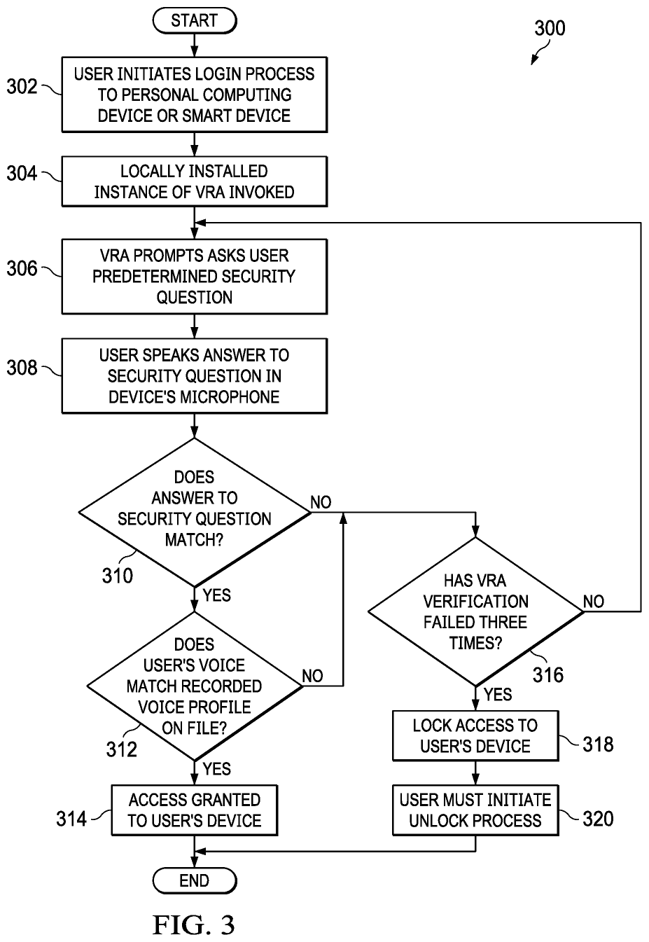

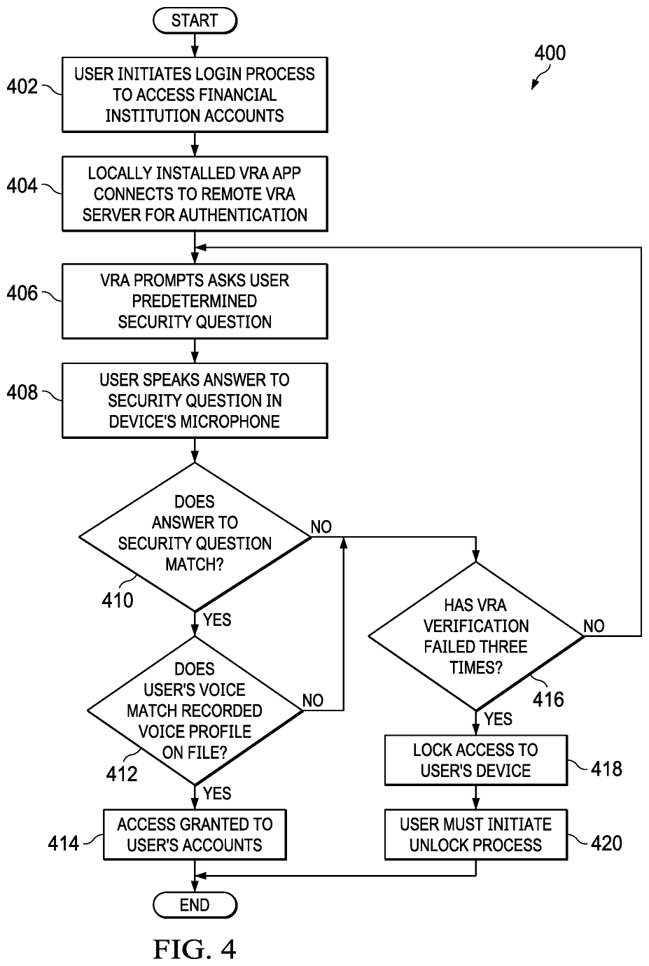

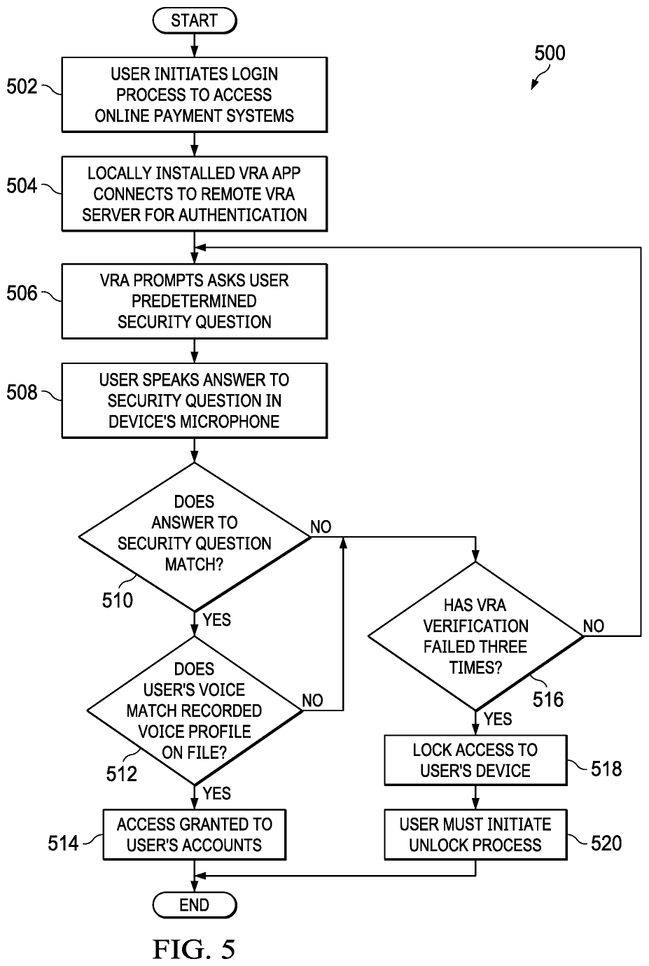

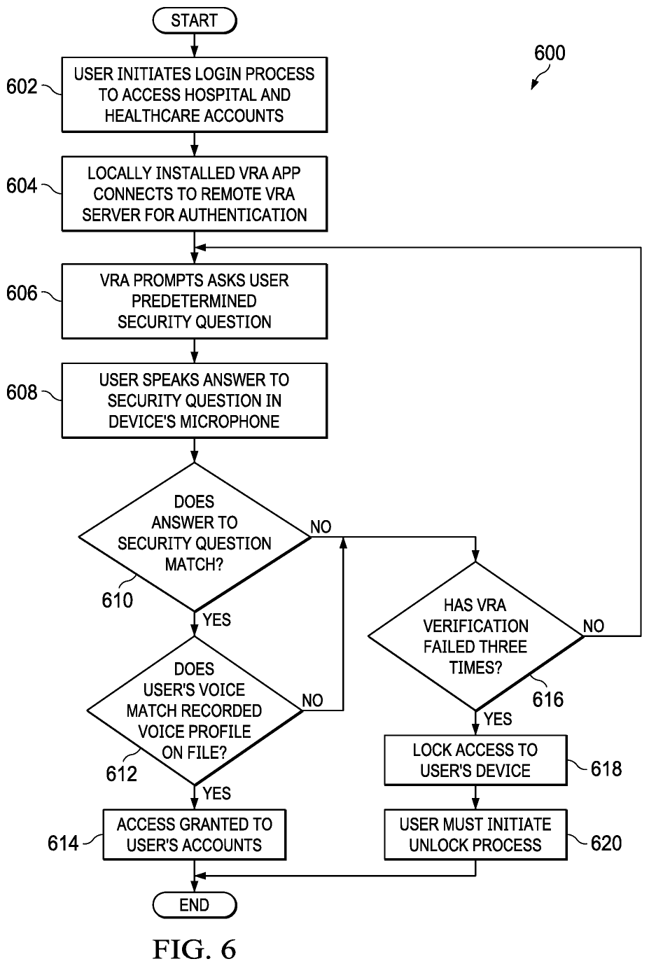

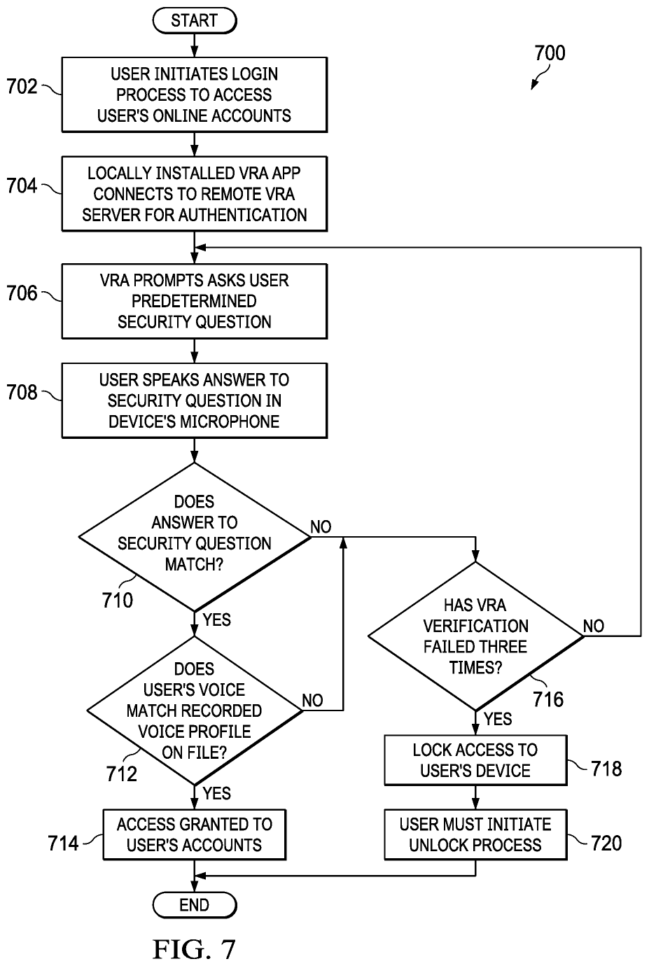

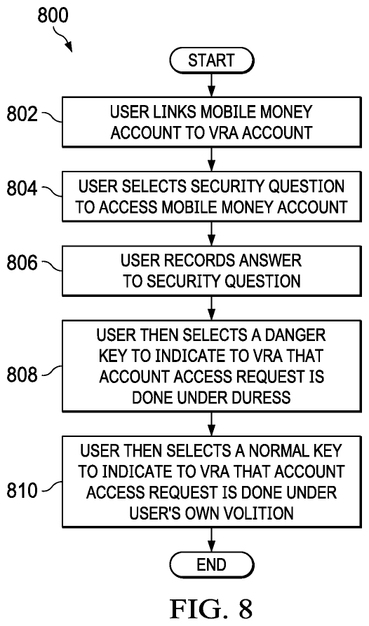

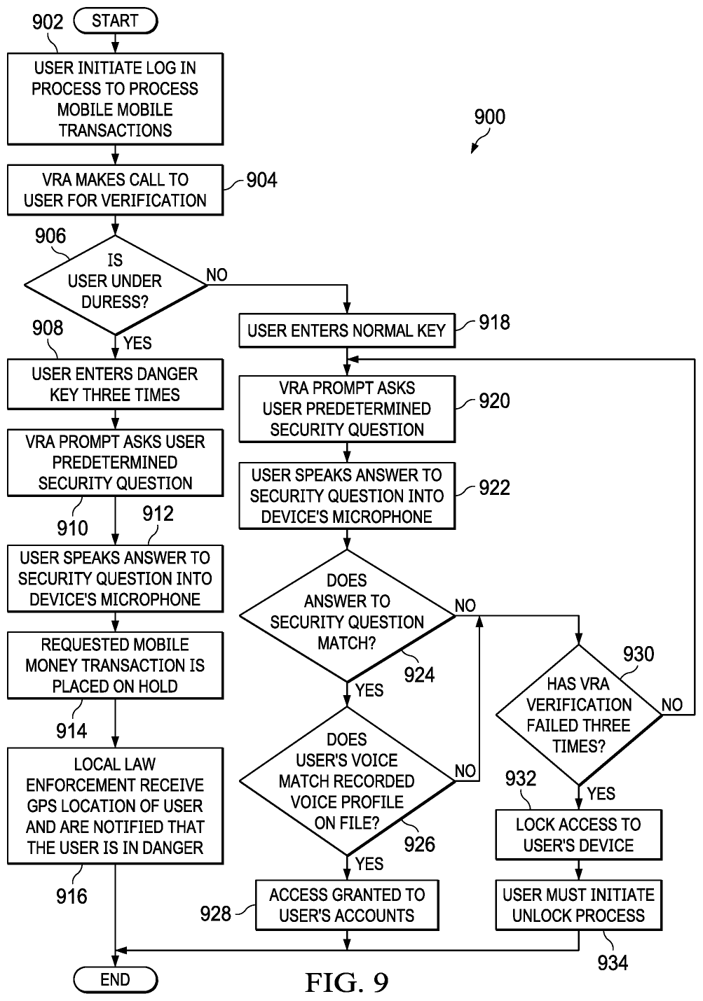

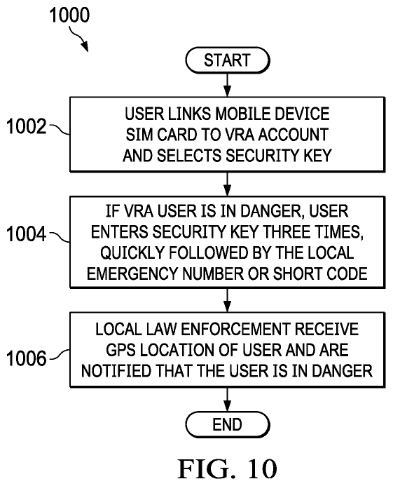

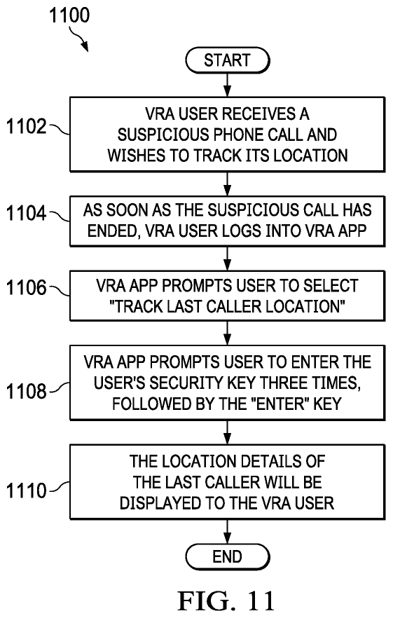

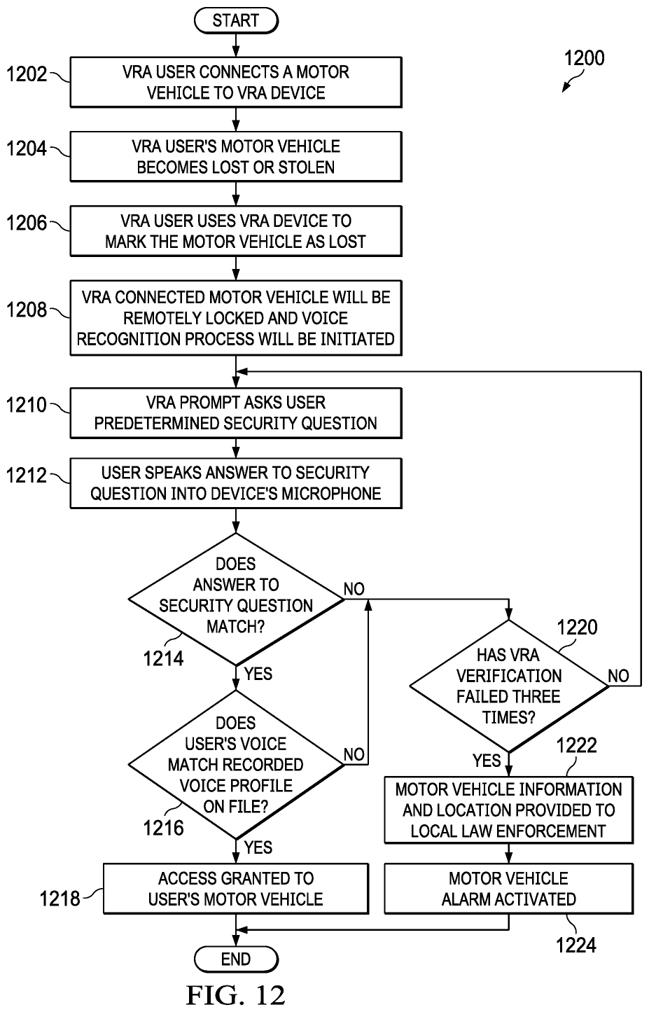

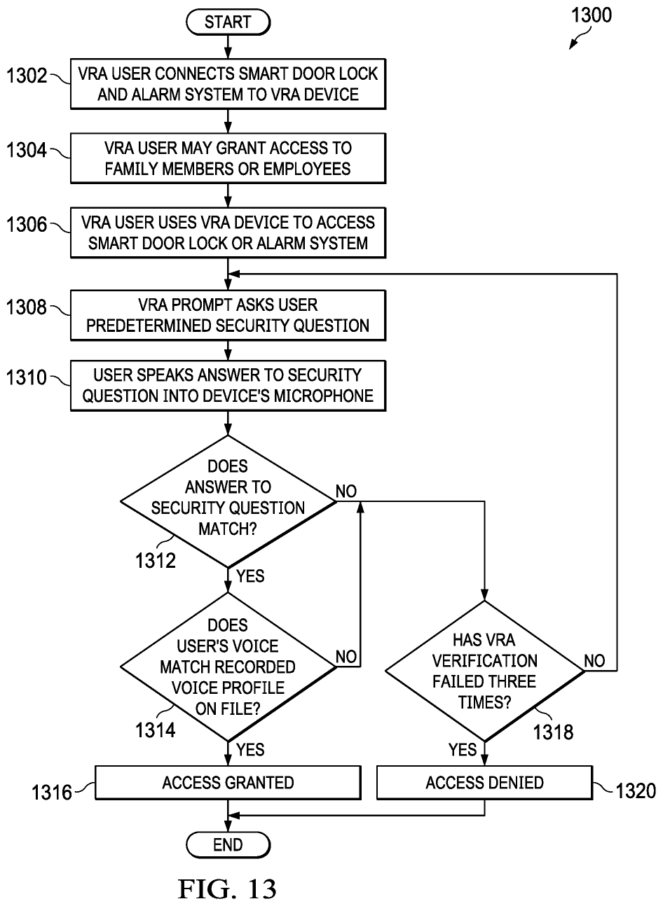

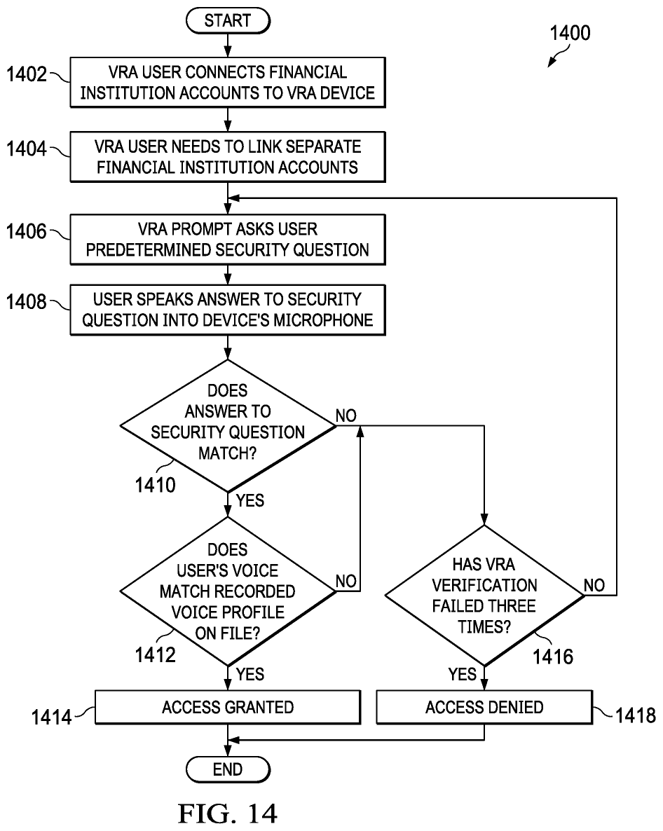

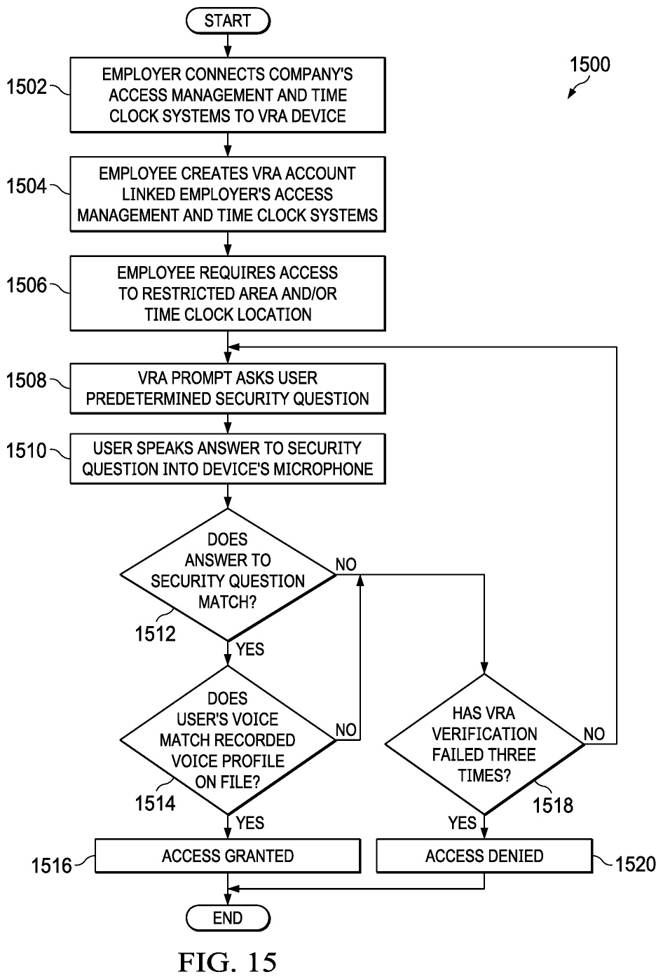

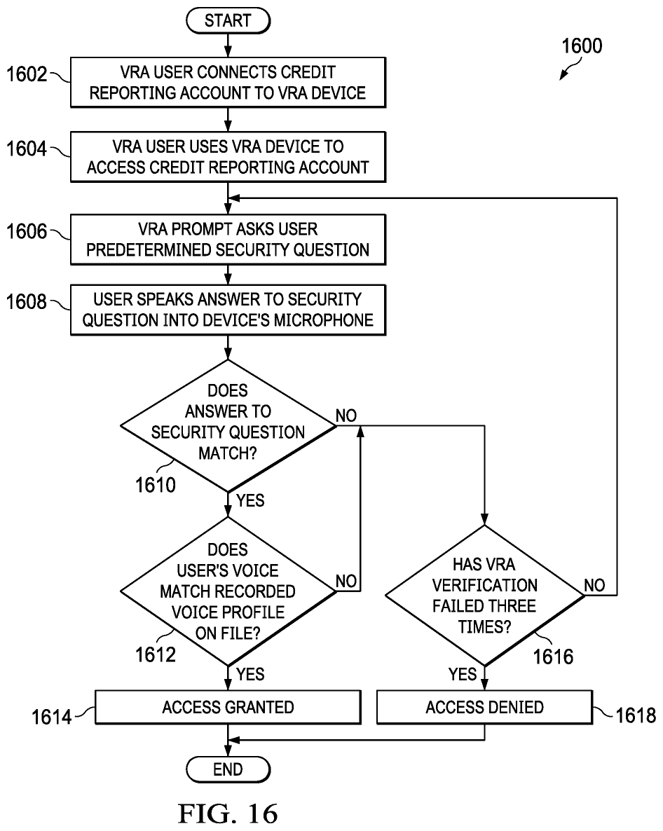

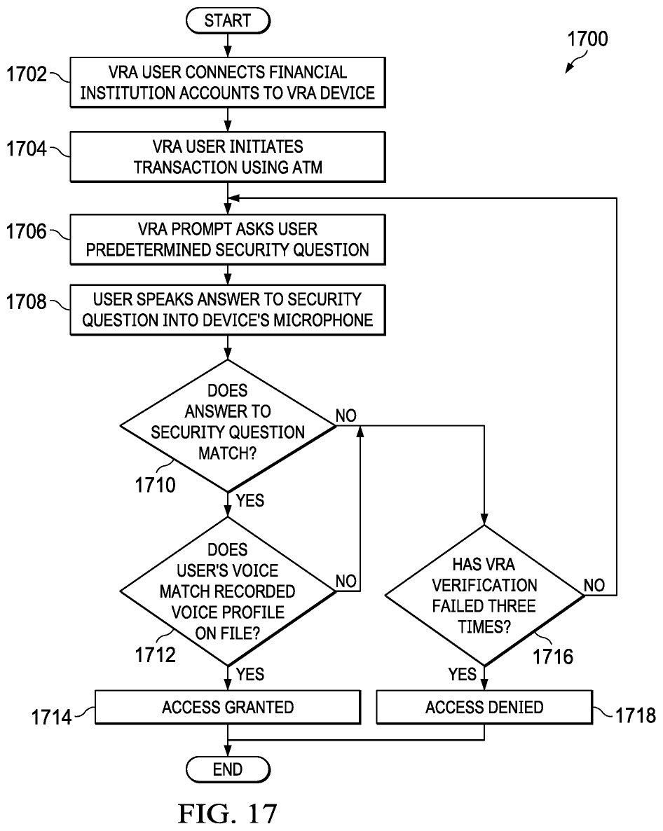

### HOW OFTEN SHOULD THIS BE DONE

The account holder may periodically update his or her voice recording as well as their security questions on file to help strengthen the security system

Also, anytime there is a transaction either in-store or online that exceeds set amount verification will be required.

Again, anytime user or account holder wants to access his or her online account at any time and in all places, verification will be required.

Language

All users will be given an option to select a language they are comfortable with. They may select from one of the following languages

American English Akan

Arabic Bengali British English Chinese French German

Hindi Japanese Javanese Korean Portuguese Russian Spanish Tamil Turkish Urdu Vietnamese

### INVENTION SUMMARY

Voice Recognition Alerts (VRA) is designed to combat unauthorized online account usage and transactions. It is an additional transaction and account management security system or an extra verification and authentication process that will be required by the various financial institutions, online payment systems, online healthcare accounts and other online accounts that contain or require user personal information such as, full name, date of birth, social security and driver's license or any government issued identification card to confirm the validity of all transactions as well account authentication before granting account access. The verification process involves making a voice recording of an answer to a selected security question on file. The account holder will then be asked to confirm transactions by verbally providing an answer to the security question. If the answer and the voice match the one recorded on file, account access or transaction will be approved. If neither the voice nor the answer matches the one file, account or transaction will be declined. If the voice matches the one recorded on file but the security answer does not match the one on file, account access will be denied. In the same way, if the security answer matches the on file, but the voice does not match the recorded one on file, account access will be denied. The system also allows mobile phone users to select a security key on their smartphone before registering their sim card. In case of an emergency where the account holder's life is in danger, the security key will be pressed three times instantly followed by their country's emergency line or short code. As soon as the user presses the key three times together with the emergency line, the system will activate the location of the user and send a signal to the nearest law enforcement that users' life is in danger.

I. (canceled)

II. (canceled)

III. (canceled)

IV. (canceled)

V. (canceled)

VI. The said invention will allow the account holder to select a security question and provide an answer to the security question in voice recording form. The voice recorded answer, will be saved on file for verification purposes.

VII. (canceled)

VIII. (canceled)

IX. (canceled)

X. (canceled)

XI. (canceled)

XII. (canceled)

XIII. (canceled)

XIV. (canceled)

XV. (canceled)

XVI. (canceled)

XVII. The said invention will allow mobile phone users to select a security key on their smartphone during the registration of their sim cards. In case of an emergency where the account holder's life is in danger, the security key will be pressed three times instantly followed by their country's emergency line or short code to activate the user's location.

XVIII. (canceled)

XIX. The said invention allows smartphone users to track a suspicious caller with the Voice Recognition alert app by logging into the VRA app and follow the system instructions.

XX. (canceled)

XXI. (canceled)

XXII. (canceled)

XXIII. (canceled)

XXIV. (canceled)

XXV. The said invention will allow users to use their voice to withdraw cash and make deposit with ATM machine.

XXVI. The said invention allows users to be able to detect gun carriers at facilities and lock the door on them

XXVII. The said invention will allow user to be able to vote with their voice.
